(19) United States
(12) Patent Application Publication
(10) Pub. No.: US 2020/0097523 A1
(43) Pub. Date: Mar. 26, 2020

(54) INFORMATION PROCESSING SYSTEM

(71) Applicant: FUJI XEROX CO., LTD., Tokyo (JP)

(72) Inventors: Masahiro SATO, Kanagawa (JP); Koki NAGATANI, Kanagawa (JP); Qian ZHANG, Kanagawa (JP); Tomoko OHKUMA, Kanagawa (JP)

(73) Assignee: FUJI XEROX CO., LTD., Tokyo (JP)

(21) Appl. No.: 16/372,413

(22) Filed: Apr. 2, 2019

(30) Foreign Application Priority Data
Sep. 26, 2018 (JP) 2018-180034

(51) Int. Cl. G06F 17/21; G06F 16/9535

(52) U.S. Cl. CPC G06F 17/211; G06F 16/9535

(57) ABSTRACT

An information processing system includes a display that displays a descriptive text describing an object, an acquirer that, in a case in which multiple objects described by the descriptive text exist, acquires information about a description format of the descriptive text describing a first object selected by a user, a specifier that specifies the description format that the user prefers based on the information about the description format acquired by the acquirer, a recommendation target decider that decides a recommendation target to recommend to the user from among the multiple objects, and a descriptive text display that displays a descriptive text describing the decided recommendation target based on the description format specified by the specifier.

### CROSS-REFERENCE TO RELATED APPLICATIONS

This application is based on and claims priority under 35 USC 119 from Japanese Patent Application No. 2018-180034 filed Sep. 26, 2018.

### BACKGROUND

### (i) Technical Field

The present disclosure relates to an information processing system.

### (ii) Related Art

Japanese Unexamined Patent Application Publication No. 2015-32186 describes how, in a case in which “soccer” and “sports” are obtained as a recommendation reason, the word itself may also be output as a related keyword, recommendation reason, or the like, and may also generate and output a predetermined sentence or the like, such as “The reason why this recommendation information was extracted is because the words “soccer” and “sports” are included in the summary.” Japanese Unexamined Patent Application Publication No. 2008-225659 describes how, in a case of recommending “recommended content A”, a recommendation reason stating “The recommended content A has better C than the content B you have viewed” is presented.

### SUMMARY

When displaying descriptive text describing a recommendation target to recommend to a user, in some cases the user's preferences regarding the description format of the descriptive text affect the degree of user interest in the recommendation target. If the set description format does not agree with the user's preferences, the probability that the user will select the recommendation target may be lowered in some cases.

Aspects of non-limiting embodiments of the present disclosure relate to raising the probability that the user will select the recommendation target compared to the case of uniformly setting the description format of the descriptive text that describes the recommendation target.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a display that displays a descriptive text describing an object, an acquirer that, in a case in which multiple objects described by the descriptive text exist, acquires information about a description format of the descriptive text describing a first object selected by a user, a specifier that specifies the description format that the user prefers based on the information about the description format acquired by the acquirer, a recommendation target decider that decides a recommendation target to recommend to the user from among the multiple objects, and a descriptive text display that displays a descriptive text describing the decided recommendation target based on the description format specified by the specifier.

### BRIEF DESCRIPTION OF THE DRAWINGS

Exemplary embodiments of the present disclosure will be described in detail based on the following figures, wherein:

FIG. 1 is a diagram illustrating an overall configuration of an information processing system according to the exemplary embodiment;

FIG. 2 is a diagram illustrating a hardware configuration of a management server;

FIG. 3 is a diagram illustrating a functional configuration of a user terminal;

FIG. 4 is a diagram illustrating an exemplary hardware configuration of a computer used as the management server and the user terminal;

FIG. 5 is a diagram illustrating an exemplary configuration of a history information management table;

FIG. 6A is a diagram listing the “user”, “product”, and “selected” items extracted from the history information management table, FIG. 6B is a diagram listing the “user”, “description style”, and “selected” items extracted from the history information management table, and FIG. 6C is a diagram listing the “product”, “description style”, and “selected” items extracted from the history information management table;

FIG. 7A is a diagram illustrating a product selection table, and FIG. 7B is a diagram illustrating a description style selection table;

FIG. 8 is a flowchart illustrating a flow of processes by the management server;

FIG. 9A is a diagram illustrating a description style selection table as an exemplary modification, and FIG. 9B is a diagram illustrating a production selection table as an exemplary modification;

FIG. 10 is a diagram illustrating a product/description style selection table;

FIG. 11 is a diagram illustrating a product/description style selection table according to a second exemplary embodiment; and

FIG. 12 is a flowchart illustrating a flow of processes by the management server.

### DETAILED DESCRIPTION

Hereinafter, exemplary embodiments of the disclosure will be described in detail and with reference to the attached drawings.

### <Configuration of Information Processing System>

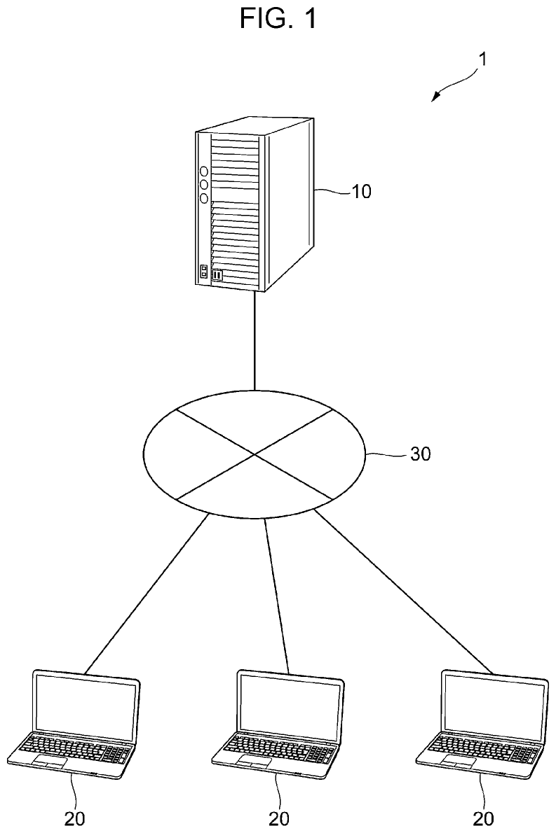

FIG. 1 is a diagram illustrating an overall configuration of an information processing system according to the present exemplary embodiment.

The information processing system 1 of the present exemplary embodiment is a system that provides a user with product information related to a product recommended to the user together with a descriptive text describing the product. Herein, a descriptive text is one or more sentences that describe the features of the product to recommend the product to a user. Examples of a descriptive text that describes a product include “recommended for men in their 20s”, “recommended for people who go out drinking”, “recommended for use with friends”, and the like. Like the above examples, the descriptive text is created using one or more description styles from among multiple description styles. A description style is a description format related to the basis for recommending the product to the user. For this reason, the description style of the descriptive text may be treated as the description format of the descriptive text. In the above example, the format of the description in the “men in their 20s”, “people who go out drinking”, and “use with friends” portions correspond to the description style.

The information processing system 1 is provided with a management server 10 and a user terminal 20. The management server 10 and the user terminal 20 are connected over a network 30.

The management server 10 is a server that manages information such as history information related to a history of user selections with respect to products recommended to the user. Also, the management server 10 analyzes the history information, performs machine learning to learn the user's preferences regarding the description styles of descriptive text and the compatibility between products and the description styles of descriptive text, and creates a predictive model on the basis of the learning results. Additionally, the created predictive model is used to decide which product to recommend to the user and which description style of descriptive text to describe the recommended product, and creates a descriptive text of the recommended product on the basis of the decided description style.

In the present exemplary embodiment, machine learning is used in the analysis of history information. However, an application program that analyzes history information in accordance with predetermined rules is also acceptable.

Note that the products include not only physical goods, but also software and services. Also, a product may be treated as a target object described by a descriptive text. Also, a product may be treated as a recommendation target to recommend to the user.

The management server 10 is realized by a computer, for example. The management server 10 may be configured as a single computer, or may be realized by distributed processing by multiple computers.

The user terminal 20 is an information processing device for acquiring product information and a descriptive text of the product. The user terminal 20 connects to the management server 10 over the network 30.

The user terminal 20 is realized by a computer, a tablet, or other kind of information processing device, for example.

The network 30 is an information communication network that handles communication between the management server 10 and the user terminal 20. The type of the network 30 is not particularly limited insofar as it is possible to transmit and receive data. For example, the network 30 may be a local area network (LAN), a wide area network (WAN), or the like. The communication channel used for data communication may be wired or wireless. A configuration that connects devices across multiple networks and communication channels is also possible.

### <Functional Configuration of Management Server>

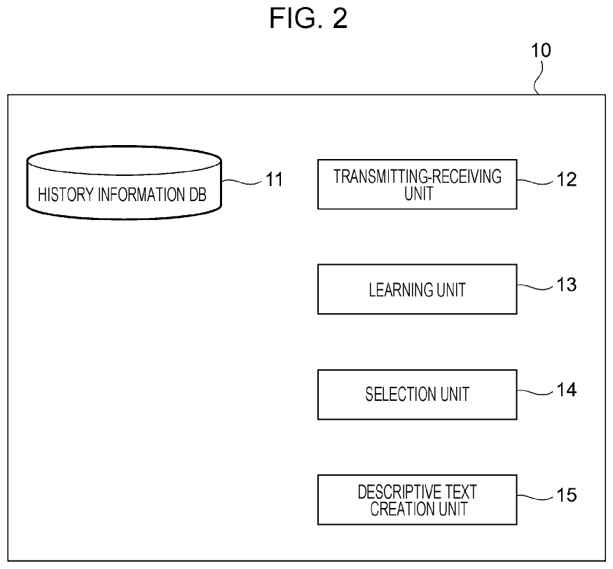

Next, a functional configuration of the management server 10 will be described. FIG. 2 is a diagram illustrating a functional configuration of the management server 10.

As illustrated in FIG. 2, the management server 10 is provided with a history information database (DB) 11. Also, the management server 10 is provided with a transmitting-receiving unit 12, a learning unit 13, a selection unit 14, and a descriptive text creation unit 15.

The history information DB 11 acting as one example of a storage unit is a database that holds history information. Examples of history information include information about the user who receives product recommendations, information about products to treat as recommendation targets, information about the description styles of descriptive text to describe recommendation targets, and the like. Also, examples of information about the user include information such as a user name, the gender of the user, the age of the user, and the like. The content of the history information held in the history information DB 11 will be described in detail later.

The transmitting-receiving unit 12 acting as one example of an acquirer is a communication unit for exchanging data with an external device. The transmitting-receiving unit 12 receives history information from the user terminal 20. Also, the transmitting-receiving unit 12 transmits product information and a descriptive text to the user terminal 20.

The learning unit 13 acting as one example of a calculator performs machine learning to learn the user's preferences regarding the description style of the descriptive text and the product, and the compatibility between the product and the description style of the descriptive text, and updates the predictive model to reflect the learning results. The machine learning is performed using the history information held in the history information DB 11.

The selection unit 14 acting as one example of a recommendation target decider selects a product to recommend to the user from among multiple products, on the basis of the predictive model created by the learning unit 13. Also, on the basis of the predictive model, the selection unit 14 selects a description style of a descriptive text describing the product from among multiple description styles. Herein, the selection unit 14 may be treated as a specifier that specifies a description style. The selection unit 14 transmits product information associated with the selected product to the user terminal 20 via the transmitting-receiving unit 12.

The descriptive text creation unit 15 creates a descriptive text describing the product selected by the selection unit 14. In this case, the descriptive text creation unit 15 creates a descriptive text on the basis of the description style selected by the selection unit 14. The descriptive text creation unit 15 transmits the created descriptive text to the user terminal 20 via the transmitting-receiving unit 12.

### <Functional Configuration of User Terminal>

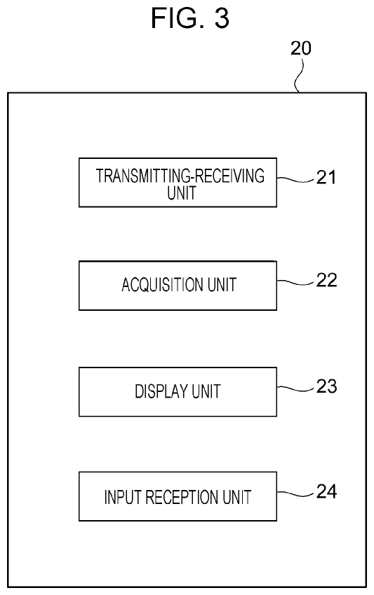

FIG. 3 is a diagram illustrating a functional configuration of the user terminal 20 according to the present exemplary embodiment. The user terminal 20 is provided with a transmitting-receiving unit 21, an acquisition unit 22, a display unit 23, and an input reception unit 24.

The transmitting-receiving unit 21 is a communication unit for exchanging data with an external device. The transmitting-receiving unit 21 transmits history information to the management server 10. Also, the transmitting-receiving unit 21 receives product information and a descriptive text from the management server 10.

The acquisition unit 22 acquires identification information of the user. The user inputs identification information into the user terminal 20 to log in, thereby causing the acquisition unit 22 to acquire the identification information and authenticate the user on the basis of the acquired identification information.

The display unit 23 is a display that displays product information. Also, the display unit 23 may be treated as a descriptive text display that displays the descriptive text describing the product.

The input reception unit 24 is a receiver that receives operations performed by the user. For example, the input reception unit 24 receives an operation of selecting a product as a recommendation target displayed on the display unit 23.

### <Hardware Configuration of Computer>

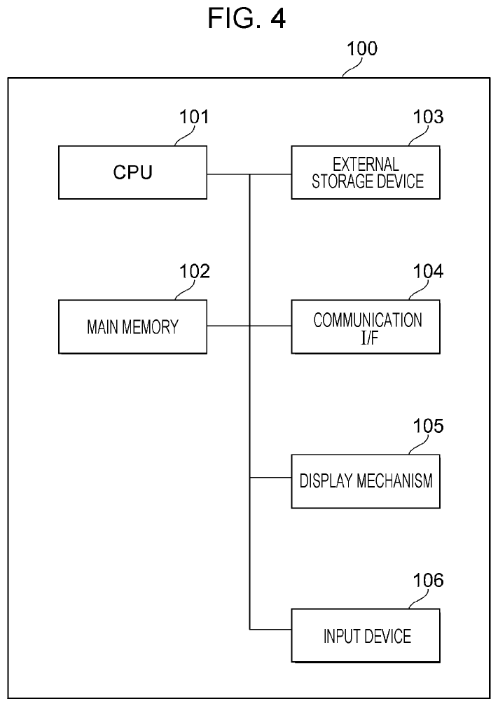

FIG. 4 is a diagram illustrating an exemplary hardware configuration of a computer used as the management server 10 and the user terminal 20. The computer 100 illustrated in FIG. 4 is provided with a central processing unit (CPU) 101 that acts as a computational component, and a main storage device (main memory) 102 and an external storage device 103 that act as storage components. The CPU 101 loads a program stored in the external storage device 103 into the main storage device 102, and executes the program. For the main storage device 102, random access memory (RAM) is used, for example. For the external storage device 103, a magnetic disk drive, a solid-state drive (SSD), or the like is used, for example. In addition, the computer 100 is provided with a communication interface 104 for connecting to a network, and a display mechanism 105 for outputting to a display. Also, the computer 100 is provided with an input device 106 on which input operations are performed by the operator of the computer 100. Note that the configuration of the computer 100 illustrated in FIG. 4 is merely one example, and the computer used in the present exemplary embodiment is not limited to the exemplary configuration of FIG. 4. For example, a configuration provided with non-volatile memory such as flash memory and read-only memory (ROM) as storage devices is also possible.

In the case in which the management server 10 illustrated in FIG. 2 is realized by the computer 100 illustrated in FIG. 4, the history information DB 11 is realized by the main storage device 102 and the external storage device 103, for example. The functions of the transmitting-receiving unit 12 are realized by the communication interface 104, for example. Each function of the learning unit 13, the selection unit 14, and the descriptive text creation unit 15 is realized by the CPU 101 executing a program, for example.

In the case in which the user terminal 20 illustrated in FIG. 3 is realized by the computer 100 illustrated in FIG. 4, the transmitting-receiving unit 21 is realized by the communication interface 104, for example. The acquisition unit 22 is realized by the CPU 101 executing a program, for example. The display unit 23 is realized by the display mechanism 105, for example. The input reception unit 24 is realized by the input device 106 and the CPU 101, for example.

Also, a program realizing an exemplary embodiment of the present disclosure obviously may be provided via a communication medium, and may also be provided by being stored on a recording medium such as CD-ROM.

### <Table Held in History Information DB>

Next, the content of the data table held in the history information DB 11 will be described.

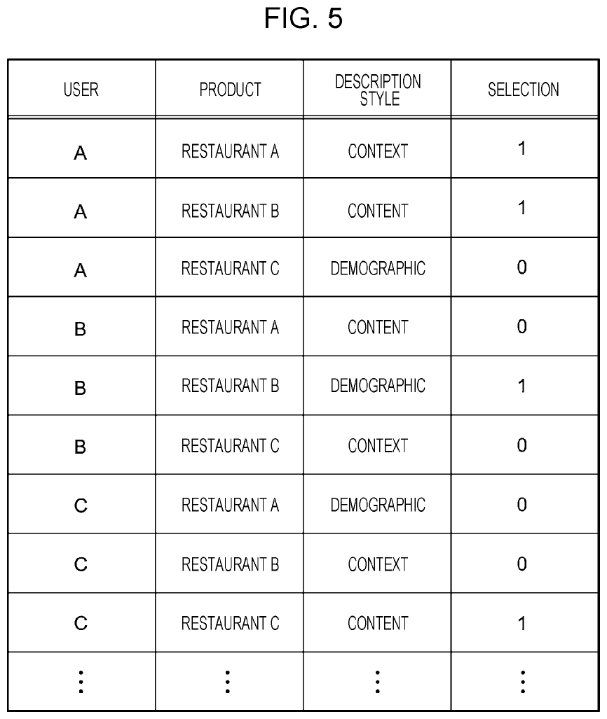

FIG. 5 is a diagram illustrating an exemplary configuration of a history information management table. The history information management table is held in the history information DB 11.

In the history information management table illustrated in FIG. 5, a user who has received a product recommendation is indicated in a “user” field. The “user” is a user authenticated in the user terminal 20 on which product information and a descriptive text transmitted from the management server 10 are displayed. Also, the product recommended to the “user” is indicated in a “product” field. The “product” is a product associated with the product information displayed on the user terminal 20. Also, the description style of the descriptive text describing the “product” is indicated in a “description style” field. The “description style” is the description style of the descriptive text displayed on the user terminal 20.

The content indicated in the “description style” will be described.

“Context” means a description style mentioning the situation in which the “product” is used. Examples of the situation in which the “product” is used include the number of people using the “product”, the relationship with the user of a peer able to use the “product” together with the user, the amount of time the “product” is used, the time period when the “product” is used, the purpose of using the “product”, and the like. One example of a “context” descriptive text is “recommended for use with friends”. This descriptive text is a descriptive text in a description style mentioning “the relationship with the user of a peer able to use the ‘product’ together with the user”.

“Content” means a description style mentioning the content of the “product”. Examples of the content of the “product” may be, for example, the type of the “product”, an attribute of the “product”, and the like. One example of a “content” descriptive text is “recommended for people who go out for sushi”. This descriptive text is a descriptive text in a description style mentioning “the type of the ‘product’”.

“Demographic” means a description style mentioning an attribute of the user who uses the “product”. Examples of user attributes include gender, age, place of residence, income, occupation, educational background, and the like. One example of a “demographic” descriptive text is “recommended for men in their 20s”. This descriptive text is a descriptive text in a description style mentioning “the gender and age of the user”.

In this way, one or more from among the three varieties of “context”, “content”, and “demographic” is indicated in the “description style”.

In addition, in the history information management table, whether or not the “user” has selected the “product” is indicated in a “selected” field. A “1” in the “selected” field means that the “user” has selected the “product” being displayed as a recommendation target on the user terminal 20. Also, a “0” indicated in the “selected” field means that the “user” has not selected the “product” as a recommendation target.

Note that “1” may also be indicated in the “selected” field in the case in which the “user” has purchased the recommended “product”, and “0” may be indicated in the “selected” field in the case in which the “user” has not purchased the recommended “product”. Whether or not the user has purchased the “product” may be determined on the basis of information related to a purchase history of the “product”, for example. Information related to a purchase history of the “product” is transmitted from the user terminal 20 to the transmitting-receiving unit 12, for example.

Also, in the case in which the “product” is a service such as a restaurant, a “1” may be indicated in the “selected” field in the case in which the “user” has made a reservation for the “product”, and a “0” may be indicated in the “selected” field in the case in which a reservation has not been made. Whether or not the user has made a reservation for the “product” may be determined on the basis of information related to a reservation history of the “product”, for example. Information related to a reservation history of the “product” is transmitted from the user terminal 20 to the transmitting-receiving unit 12, for example.

Also, a “1” may be indicated in the “selected” field in the case in which the “user” has rated the “product” using the user terminal 20, and a “0” may be indicated in the “selected” field in the case in which the “product” has not been rated. Herein, Examples of “the case in which the ‘user’ has rated the ‘product’” include the case in which the “user” has input impressions about the “product” using the user terminal 20, the case in which the “user” has input an operation indicating an intent to support the “product”, and the like. Also, examples of “the case in which the ‘user’ has not rated the ‘product’” include the case in which the “user” has not input impressions about the “product” using the user terminal 20, the case in which the “user” has not input an operation indicating an intent to support the “product”, and the like. Whether or not the user has rated the “product” may be determined on the basis of information related to a rating history of the “product”, for example. Information related to a rating history of the “product” is transmitted from the user terminal 20 to the transmitting-receiving unit 12, for example.

### <Processes of Learning Unit>

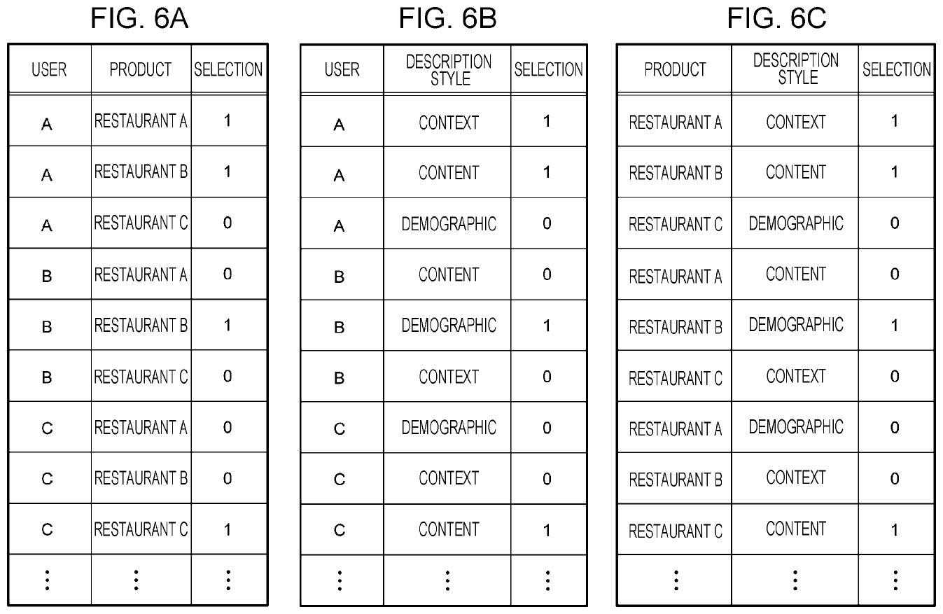

Next, one example of processes by the learning unit 13 will be described. FIG. 6A is a diagram listing the “user”, “product”, and “selected” items extracted from the history information management table (see FIG. 5). Also, FIG. 6B is a diagram listing the “user”, “description style”, and “selected” items extracted from the history information management table. Also, FIG. 6C is a diagram listing the “product”, “description style”, and “selected” items extracted from the history information management table.

The learning unit 13 uses the information illustrated in FIG. 6A to learn user preferences regarding products. Specifically, the learning unit 13 learns the preferences of the “user” with respect to the “product” on the basis of whether or not the “product” recommended to the “user” was “selected” by the “user”. Even more specifically, the learning unit 13 uses the “product” “selected” by the “user” as a positive example indicating a “product” that the “user” prefers, and uses the “product” not “selected” by the “user” as a negative example indicating a “product” that the “user” does not prefer.

In the illustrated example, the learning unit 13 uses “restaurant A” and “restaurant B” “selected” by the user “A” as positive examples indicating a “product” that the user “A” prefers. Also, the “restaurant C” not “selected” by the user “A” is used as a negative example indicating a “product” that the user “A” does not prefer.

Also, the learning unit 13 uses the “restaurant B” “selected” by the user “B” as a positive example indicating a “product” that the user “B” prefers. Also, the “restaurant A” and the “restaurant C” not “selected” by the user “B” are used as negative examples indicating a “product” that the user “B” does not prefer.

Also, the learning unit 13 uses the “restaurant C” “selected” by the user “C” as a positive example indicating a “product” that the user “C” prefers. Also, the “restaurant A” and the “restaurant B” not “selected” by the user “C” are used as negative examples indicating a “product” that the user “C” does not prefer.

In the illustrated example, the user preferences regarding each “product” are different for each “user”.

The learning unit 13 creates a “predictive model of products that the user prefers” on the basis of the obtained positive examples and negative examples. The learning unit 13 creates the predictive model without considering the user preferences regarding description styles or the compatibility between the product and the description style. Also, the learning unit 13 updates the created predictive model every time a positive example or a negative example is obtained.

The learning unit 13 uses the information illustrated in FIG. 6B to learn user preferences regarding description styles. Specifically, the learning unit 13 learns the preferences of the “user” with respect to the “description style” on the basis of whether or not a product associated with a descriptive text created on the basis of the “description style” was “selected” by the “user”. Hereinafter, the “description style” of a descriptive text of a product “selected” by the “user” will be designated a “description style” “selected” by the “user”. Also, the “description style” of a descriptive text of a product not “selected” by the “user” will be designated a “description style” not “selected” by the “user”.

The learning unit 13 uses the “description style” “selected” by the “user” as a positive example indicating a “description style” that the “user” prefers, and uses the “description style” not “selected” by the “user” as a negative example indicating a “description style” that the “user” does not prefer.

In the illustrated example, the learning unit 13 uses “context” and “content” “selected” by the user “A” as positive examples indicating a “description style” that the user “A” prefers. Also, “demographic” not “selected” by the user “A” is used as a negative example indicating a “description style” that the user “A” does not prefer.

Also, the learning unit 13 uses “demographic” “selected” by the user “B” as a positive example indicating a “description style” that the user “B” prefers. Also, “content” and “context” not “selected” by the user “B” are used as negative examples indicating a “description style” that the user “B” does not prefer.

Also, the learning unit 13 uses “content” “selected” by the user “C” as a positive example indicating a “description style” that the user “C” prefers. Also, “demographic” and “context” not “selected” by the user “C” are used as negative examples indicating a “description style” that the user “C” does not prefer.

In the illustrated example, the user preferences regarding each “description style” are different for each user.

The learning unit 13 creates a “predictive model of description styles that the user prefers” on the basis of the obtained positive examples and negative examples. The learning unit 13 creates the predictive model without considering the user preferences regarding products or the compatibility between the product and the description style. Also, the learning unit 13 updates the created predictive model every time a positive example or a negative example is obtained.

The learning unit 13 uses the information illustrated in FIG. 6C to learn the compatibility between products and description styles. Specifically, the learning unit 13 learns the compatibility between a “product” and a “description style” on the basis of whether or not the “product” associated with a descriptive text created on the basis of the “description style” was “selected” by a user. Hereinafter, the “description style” of a descriptive text describing a “product” will be designated the “description style” associated with the “product”.

The learning unit 13 uses the “product” “selected” by a user and the “description style” associated with the “product” as a positive example indicating good compatibility between the “product” and the “description style”. Also, the learning unit 13 uses the “product” not “selected” by a user and the “description style” associated with the “product” as a negative example indicating poor compatibility between the “product” and the “description style”.

In the illustrated example, the learning unit 13 uses the “restaurant A” “selected” by a user and “context” associated with the “restaurant A” as a positive example indicating good compatibility between the “product” and the “description style”. Also, the “restaurant A” not “selected” by a user and “content” as well as “demographic” associated with the “restaurant A” are used as negative examples indicating poor compatibility between the “product” and the “description style”.

Additionally, for example, the learning unit 13 uses the “restaurant B” “selected” by a user and “content” as well as “demographic” associated with the “restaurant B” as positive examples indicating good compatibility between the “product” and the “description style”. Also, the “restaurant B” not “selected” by a user and “context” associated with the “restaurant B” are used as a negative example indicating poor compatibility between the “product” and the “description style”.

Additionally, for example, the learning unit 13 uses the “restaurant C” “selected” by a user and “content” associated with the “restaurant C” as a positive example indicating good compatibility between the “product” and the “description style”. Also, the “restaurant C” not “selected” by a user and “demographic” as well as “context” associated with the “restaurant C” are used as negative examples indicating poor compatibility between the “product” and the “description style”.

In the illustrated example, the compatibility between the “product” and the “description style” is different for each product and each description style.

The learning unit 13 creates a “predictive model of combinations of products and description styles with good compatibility” on the basis of the obtained positive examples and negative examples. The learning unit 13 creates the predictive model without considering the user preferences regarding products or the user preferences regarding description styles. Also, the learning unit 13 updates the created predictive model every time a positive example or a negative example is obtained.

### <Processes of Selection Unit>

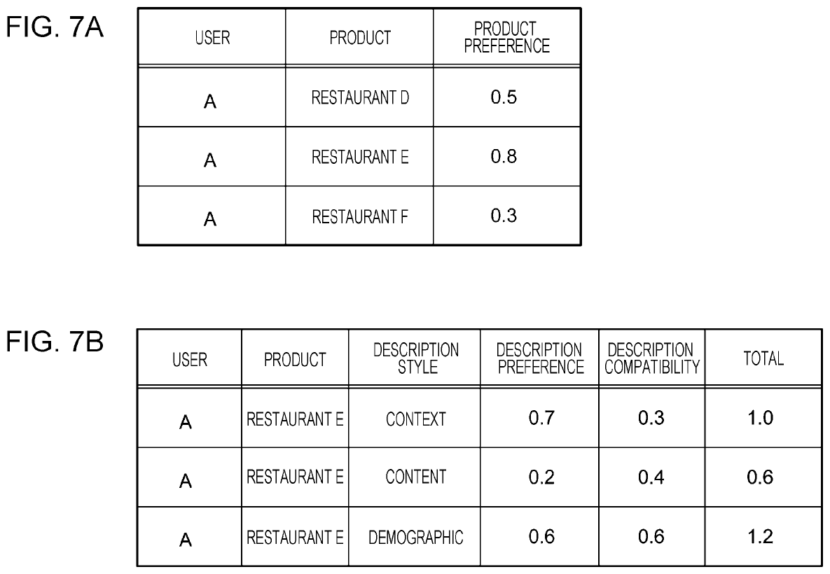

Next, one example of a selection process by which the selection unit 14 selects a product and a description style of a descriptive text to recommend to a user will be described. FIG. 7A is a diagram illustrating a product selection table. Also, FIG. 7B is a diagram illustrating a description style selection table.

The product selection table illustrated in FIG. 7A is a table by which the selection unit 14 selects a product to recommend to a user. The selection unit 14 creates the product selection table on the basis of the “predictive model of products that the user prefers” created by the learning unit 13. Also, the selection unit 14 creates a product selection table for each user.

In the product selection table, the user receiving product recommendations is indicated in a “user” field. Also, the products treated as recommendation target candidates are indicated in a “product” field. Also, a value computed on the basis of the predictive model as the degree to which the “user” prefers the “product” is indicated in a “product preference” field. A higher value indicated in the “product preference” field means that a higher degree to which the “user” prefers the “product” has been computed.

The selection unit 14 selects the “product” associated with the highest “product preference” from among the “products” indicated in the product selection table as the target to recommend to the “user”. In the illustrated example, the selection unit 14 selects the “restaurant E” associated with the highest “product preference” of “0.8” as the target to recommend to the user “A”.

Next, the selection unit 14 creates the description style selection table illustrated in FIG. 7B on the basis of the predictive model created by the learning unit 13. The description style selection table is a table by which the selection unit 14 selects a description style of a descriptive text of a product to recommend to a user. The selection unit 14 creates a description style selection table in association with a product selected as a recommendation target.

In the description style selection table, the user receiving product recommendations is indicated in a “user” field. Also, the product selected as the recommendation target using the product selection table is indicated in a “product” field. Also, the description style treated as a candidate to be used for the descriptive text of the “product” is indicated in a “description style” field. Also, a value computed on the basis of the “predictive model of description styles that the user prefers” as the degree to which the “user” prefers the “description style” is indicated in a “description preference” field. Also, a value computed on the basis of the “predictive model of combinations of products and description styles with good compatibility” as the compatibility between the “product” and the “description style” is indicated in a “description compatibility” field. Also, the total value of the “description preference” and the “description compatibility” is indicated in a “total” field.

Note that the “description preference” may be treated as an indicator related to a user preference with respect to the description style. Also, the “description compatibility” may be treated as a compatibility indicator related to the compatibility between a product and a description style.

A higher value indicated in the “description preference” field means that a higher degree to which the “user” prefers the “description style” has been computed. Also, a higher value indicated in the “description compatibility” field means that a higher compatibility between the “product” and the “description style” has been computed.

The selection unit 14 selects the “description style” associated with the highest “total” from among the “description styles” indicated in the description style selection table as the description style to be used in the descriptive text of the “product” to recommend to the “user”. In the illustrated example, the selection unit 14 selects “demographic” associated with the highest “total” of “1.2” as the description style to be used in the descriptive text of the “restaurant E” to recommend to the user “A”.

### <Flow of Processes by Management Server>

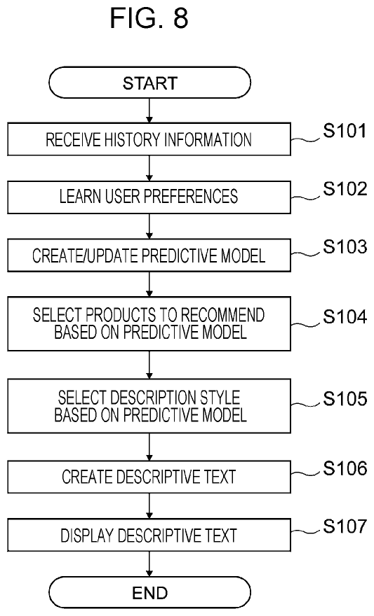

Next, the flow of processes by the management server 10 will be described. FIG. 8 is a flowchart illustrating a flow of processes by the management server 10.

First, the transmitting-receiving unit 12 of the management server 10 receives history information transmitted from the user terminal 20 (S101). The history information received by the transmitting-receiving unit 12 is stored in the history information DB 11.

On the basis of the history information stored in the history information DB 11, the learning unit 13 learns user preferences regarding products, user preferences regarding description styles, and the compatibility between products and description styles (S102). Subsequently, on the basis of the learning results, predictive models are created and created predictive models are updated (S103).

The selection unit 14 selects a product to recommend to a user on the basis of the predictive models created by the learning unit 13 (S104). Also, a description style of the descriptive text of the product is selected on the basis of the predictive models (S105).

The descriptive text creation unit 15 creates a descriptive text of the product selected by the selection unit 14 on the basis of the description style selected by the selection unit 14 (S106). Additionally, the created descriptive text is transmitted to the user terminal 20 via the transmitting-receiving unit 12 and displayed on the user terminal 20 (S107).

In this way, in the present exemplary embodiment, information about the description style of the descriptive text describing a single product selected by the user is acquired, and on the basis of the acquired information, a description style that the user prefers is specified. Subsequently, a descriptive text describing a product to recommend to the user is displayed on the basis of the specified description style.

Also, in the present exemplary embodiment, on the basis of the information about the description style of the descriptive text describing a single product selected by the user, a combination of a product and a description style that the user prefers is specified. Subsequently, a descriptive text describing the specified product on the basis of the specified description style is displayed.

When recommending a product to a user, when displaying descriptive text describing the product, in some cases the user's preferences regarding the description style of the descriptive text affect the degree of user interest in the product. Also, since user preferences regarding description styles are different for each user, if the description style is set uniformly, depending on the user, the set description style may not agree with the user's preferences in some cases. If the set description style does not agree with the user's preferences, the probability that the user will select the product may be lowered in some cases.

Accordingly, in the present exemplary embodiment, the description style of a descriptive text of a single product to recommend to a user is set to a description style in accordance with the user on the basis of the “predictive model of description styles that the user prefers”.

Also, in the present exemplary embodiment, the description style of a descriptive text of a product to recommend to a single user is set to a description style in accordance with the product to recommend on the basis of the “predictive model of combinations of products and description styles with good compatibility”.

Also, in the present embodiment, the learning unit 13 creates the predictive models on the basis of positive examples and negative examples, and specifies a description style on the basis of the created predictive models.

In other words, a description style is specified on the basis of information about the description style of the descriptive text associated with a product selected by the user and information about the description style of the descriptive text associated with a product not selected by the user. Specifically, a description preference is computed on the basis of information about the description style of the descriptive text associated with a product selected by the user and information about the description style of the descriptive text associated with a product not selected by the user. Subsequently, a description style is specified on the basis of the computed description preference.

Also, in the present exemplary embodiment, the description style of a descriptive text displayed on the user terminal 20 is a description format associated with the basis for recommending the product to the user. Furthermore, the description format associated with the basis for recommending the product is a description format of features of the product in a category to which the user's preferences belong. Examples of categories to which the user's preferences belong include “content”, “context”, and “demographic”, and the like, for example.

Also, in the present exemplary embodiment, first, a product is decided as a recommendation target, and the description compatibility related to the compatibility between the decided product and the description style is computed. Subsequently, a description style is specified on the basis of the computed description compatibility.

### <Exemplary Modification 1>

Next, an exemplary modification of the selection process by the selection unit 14 will be described.

The selection process by the selection unit 14 is not limited to the above.

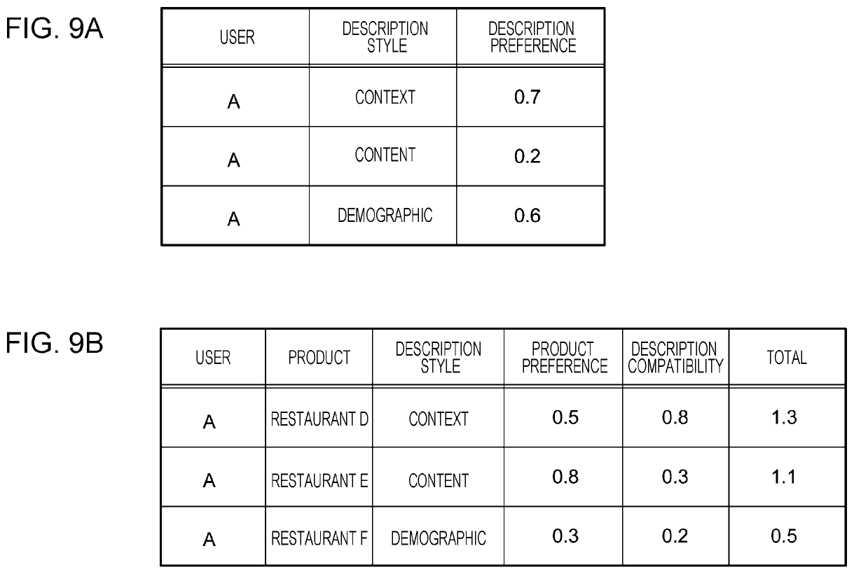

FIG. 9A is a diagram illustrating a description style selection table as an exemplary modification, and FIG. 9B is a diagram illustrating a production selection table as an exemplary modification.

In the description style selection table illustrated in FIG. 9A, the user receiving product recommendations is indicated in a “user” field. Also, the description style treated as a candidate to be used for the descriptive text of the product is indicated in a “description style” field. Also, a value computed on the basis of the “predictive model of description styles that the user prefers” as the degree to which the “user” prefers the “description style” is indicated in a “description preference” field.

The selection unit 14 selects the “description style” with the highest “description preference” from among the “description styles” indicated in the description style selection table as the description style of the descriptive text of the product to recommend to the “user”. In the illustrated example, the selection unit 14 selects “context” with the highest “description preference” of “0.7” as the description style of the descriptive text of the product to recommend to the user “A”.

Next, the selection unit 14 creates the product selection table illustrated in FIG. 9B on the basis of the predictive model created by the learning unit 13. In the product selection table, the user receiving product recommendations is indicated in a “user” field. Also, the products treated as recommendation target candidates are indicated in a “product” field. Also, the description style selected using the description style selection table is indicated in a “description style” field. Also, a value computed on the basis of the “predictive model of products that the user prefers” as the degree to which the “user” prefers the “product” is indicated in a “product preference” field. Also, a value computed on the basis of the “predictive model of combinations of products and description styles with good compatibility” as the compatibility between the “product” and the “description style” is indicated in a “description compatibility” field. Also, the total value of the “product preference” and the “description compatibility” is indicated in a “total” field.

The selection unit 14 selects the “product” associated with the highest “total” from among the “products” indicated in the product selection table as the product to recommend to the “user”. In the illustrated example, the selection unit 14 selects the “restaurant D” associated with the highest “total” of “1.3” as the product to recommend to the user “A”.

In this way, first, the description style that the user prefers may be specified, and the description compatibility related to the compatibility between the specified description style and products may be computed. Subsequently, a product may be decided as the recommendation target on the basis of the computed description compatibility.

Note that the “user”, “product”, and “description style” fields as well as the values of the “description preference” and “product preference” fields illustrated in FIGS. 9A and 9B are the same as the “user”, “product”, and “description style” fields as well as the values of the “description preference” and “product preference” fields illustrated in FIGS. 7A and 7B. On the other hand, in the exemplary description using FIGS. 7A and 7B, “restaurant E” is selected as the recommendation target and “demographic” is selected as the description style, but in contrast, in the exemplary description using FIGS. 9A and 9B, the “restaurant D” is selected as the recommendation target and “context” id selected as the description style. In other words, in the case of selecting a product as the recommendation target and a description style on the basis of the description compatibility, the selected description style and product may change depending on the order in which the selection of the “description style” and the selection of the “product” are performed.

### <Exemplary Modification 2>

Next, an exemplary modification (Exemplary Modification 2) of the selection process by the selection unit 14 will be described.

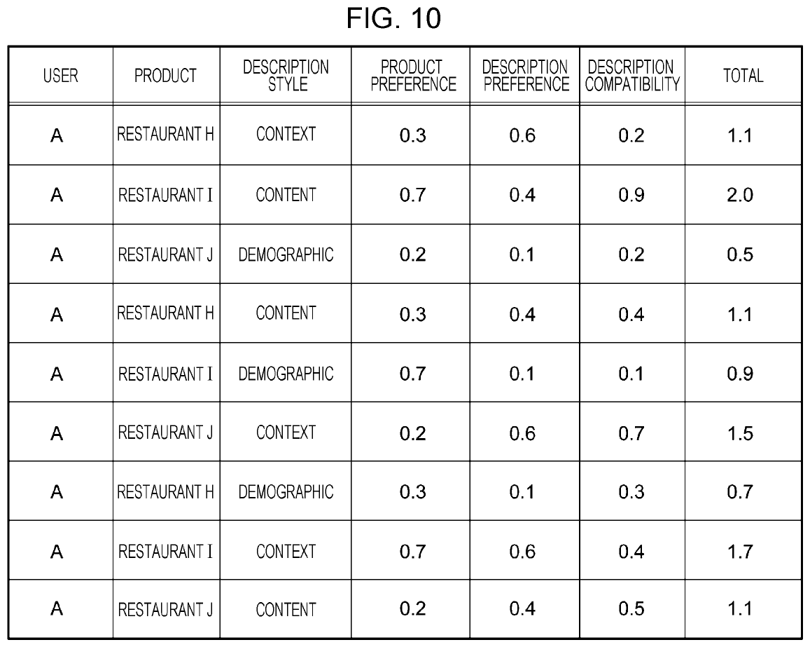

FIG. 10 is a diagram illustrating a product/description style selection table.

The product/description style selection table illustrated in FIG. 10 is a table by which the selection unit 14 selects a product to recommend to a user and a description style of a descriptive text of the product at the same time. The selection unit 14 creates the product/description style selection table on the basis of the predictive models created by the learning unit 13. Also, the selection unit 14 creates a product/description style selection table for each user.

In the product/description style selection table, the user receiving product recommendations is indicated in a “user” field. Also, the products treated as recommendation target candidates are indicated in a “product” field. Also, the description style treated as a candidate to be used for the descriptive text of the “product” is indicated in a “description style” field. Also, a value computed on the basis of the “predictive model of products that the user prefers” as the degree to which the “user” prefers the “product” is indicated in a “product preference” field. Also, a value computed on the basis of the “predictive model of description styles that the user prefers” as the degree to which the “user” prefers the “description style” is indicated in a “description preference” field. Also, a value computed on the basis of the “predictive model of combinations of products and description styles with good compatibility” as the compatibility between the “product” and the “description style” is indicated in a “description compatibility” field. Also, the total value of the “product preference”, the “description preference”, and the “description compatibility” is indicated in a “total” field.

The selection unit 14 selects the “product” associated with the highest “total” from among the “products” indicated in the product/description style selection table as the “product” to recommend to the “user”. Also, the “description style” associated with the highest “total” is selected as the description style to be used in the descriptive text of the “product” to recommend to the “user”.

In the illustrated example, the selection unit 14 selects the “restaurant I” associated with the highest “total” of “2.0” as the product to recommend to the user “A”. Also, “content” associated with the highest “total” of “2.0” is selected as the description style to be used in the descriptive text of the “restaurant I” to recommend to the user “A”.

In this way, the selection unit 14 may specify a description style and also decide a product to act as the recommendation target on the basis of the description compatibility.

Note that the present exemplary embodiment describes selecting only the product and the description style associated with the indicator of highest value from among the indicators computed on the basis of predictive models, but is not limited thereto.

For example, the products and description styles associated with a predetermined number of indicators of highest value (for example, the top 3) from among the computed indicators may be selected. In other words, the number of products to recommend to a user using descriptive text in the selected description styles is not limited to one.

Also, for example, all products and description styles associated with indicators equal to or greater than a predetermined value from among the indicators computed on the basis of the predictive models may be selected. In this case, in the case in which a product or a description style associated with an indicator equal to or greater than the predetermined value does not exist, a product may not be recommended to the user.

In addition, multiple types of description styles may also be used for the description style of a single descriptive text. Multiple types of description styles include, for example, “context and content”, “context and demographic”, and the like. One example of a descriptive text with multiple types of description styles is “recommended for men in their 20s who go out for sushi”. This descriptive text is a descriptive text in the two description styles of “content and demographic”.

In this case, information related to the number of description styles is made to be included in the history information that the transmitting-receiving unit 12 receives from the user terminal 20. Subsequently, the learning unit 13 learns user preferences regarding the number of description styles, and creates a predictive model of the number of description styles that the user prefers on the basis of the learning result. On the basis of the predictive model, the number of description styles that the user prefers may be specified.

Also, the present exemplary embodiment is described as having the “technique of selecting a product to act as the recommendation target and then selecting a description style” described using FIGS. 7A and 7B, the “technique of selecting a description style and then selecting a product to act as the recommendation target” described using FIGS. 9A and 9B, and the “technique of selecting a product to act as the recommendation target and a description style at the same time” described using FIG. 10.

At this point, which technique to use to select a description style and a product to act as the recommendation target may be decided according to the number of existing indicators which are equal to or greater than a predetermined value from among the indicators computed on the basis of the predictive models, for example. For example, the number of “product preference” items equal to or greater than a predetermined value in the product selection table illustrated in FIG. 7A may be compared to the number of “description preference” items equal to or greater than a predetermined value in the description style selection table illustrated in FIG. 9A, and the technique with the greater number of items may be used, or the technique with the lesser number of items may be used. Also, for example, in the case in which the number of “total” items equal to or greater than a predetermined value in the product/description style selection table illustrated in FIG. 10 is a predetermined number or greater, the “technique of selecting a product to act as the recommendation target and the description style at the same time” may be used. Furthermore, in the case in which the number of “total” items is the predetermined value or less, the “technique of selecting a product to act as the recommendation target and the description style at the same time” may be used.

Also, the present exemplary embodiment describes creating each of the “predictive model of products that the user prefers”, the “predictive model of description styles that the user prefers”, and the “predictive model of combinations of products and description styles with good compatibility”, but is not limited thereto. For example, a “predictive model of products that the user prefers, description styles that the user prefers, and combinations of products and description styles with good compatibility” may be created, and on the basis of this single created predictive model, each of the indicators related to user preferences regarding products, indicators related to user preferences regarding description styles, and indicators related to the compatibility between products and description styles may be computed.

### Second Exemplary Embodiment

Next, a second exemplary embodiment will be described.

The second exemplary embodiment shares in common with the first exemplary embodiment the point of setting a product to recommend to a user and a description style of a descriptive text of the product depending on the user.

On the other hand, whereas the first exemplary embodiment is a technique of specifying a product to recommend to a user and a description style of a descriptive text of the product on the basis of user preferences regarding description styles and the compatibility between the product and the description style, the second exemplary embodiment is a technique different from the first exemplary embodiment.

Namely, in the second exemplary embodiment, user preferences regarding products from multiple categories are learned by machine learning on the basis of a history of user selections with respect to products recommended to the user and a user search history of products, and from the learning results, a predictive model of products that the user prefers is created. Subsequently, the created predictive model is used to compute indicators related to the user preferences regarding products in multiple categories, and on the basis of the computed indicators, a product to recommend to the user is decided. Furthermore, a description style is specified on the basis of the category that contributed the most to the decision of the product to recommend to the user.

Note that in the second exemplary embodiment, description will be omitted for configuration elements similar to the first exemplary embodiment.

The transmitting-receiving unit 12 of the second exemplary embodiment receives history information from the user terminal 20. The history information includes information such as a history of user selections (selection history) with respect to products recommended to the user, and a search history of products that the user has searched for using the user terminal 20. The history information received by the transmitting-receiving unit 12 is stored in the history information DB 11.

The learning unit 13 uses the history information stored in the history information DB 11 to perform machine learning and learn the user's preferences regarding products. Specifically, the learning unit 13 learns the user's preferences regarding products from the three categories of “situation in which product is used”, “content of product”, and “user attribute”. As the machine learning technique, for example, feature-based matrix factorization, factorization machines, field-aware factorization machines, or the like may be used. Subsequently, a predictive model of products that the user prefers is created on the basis of the learned result. Also, the learning unit 13 creates a predictive model of products that the user prefers on the basis of the content of products included in the selection history and the search history.

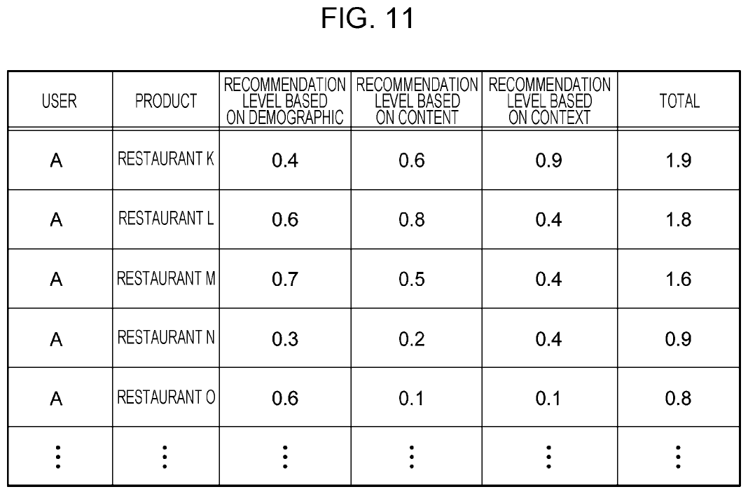

FIG. 11 is a diagram illustrating a product/description style selection table according to the second exemplary embodiment.

In the product/description style selection table according to the second exemplary embodiment, the user receiving product recommendations is indicated in a “user” field. Also, the products treated as recommendation target candidates are indicated in a “product” field. Also, a value computed as a degree to which the “user” prefers the “product” in the category of “user attribute” on the basis of the predictive model is indicated in a “recommendation level based on demographic” field. Also, a value computed as a degree to which the “user” prefers the “product” in the category of “content of product” on the basis of the predictive model is indicated in a “recommendation level based on content” field. Also, a value computed as a degree to which the “user” prefers the “product” in the category of “situation in which product is used” on the basis of the predictive model is indicated in a “recommendation level based on context” field. Also, the total value of the “recommendation level based on demographic”, the “recommendation level based on content”, and the “recommendation level based on context” is indicated in a “total” field.

The selection unit 14 selects the “product” associated with the highest “total” from among the “products” indicated in the product/description style selection table as the target to recommend to the user. In the illustrated example, the selection unit 14 selects the “restaurant K” associated with the highest “total” of “1.9” as the target to recommend to the user “A”.

Furthermore, the selection unit 14 selects a description style on the basis of the category related to the item associated with the highest value from among the items associated with the selected “product”. In other words, the selection unit 14 selects the category related to the item associated with the highest value as the category that contributed the most to the decision of the product as the recommendation target.

For example, in the case in which the item associated with the highest value is the “recommendation level based on demographic”, the selection unit 14 selects “demographic” on the basis of “user attribute” for the description style to be used in the descriptive text of the “product”. Also, in the case in which the item associated with the highest value is the “recommendation level based on content”, the selection unit 14 selects “content” on the basis of “content of product” for the description style to be used in the descriptive text of the “product”. Also, in the case in which the item associated with the highest value is the “recommendation level based on context”, the selection unit 14 selects “context” on the basis of “situation in which product is used” for the description style to be used in the descriptive text of the “product”.

In the illustrated example, from among the items associated with the “restaurant K”, the “recommendation level based on context” has the highest value of “0.9”. For this reason, the selection unit 14 selects “context” for the description style to be used in the descriptive text of the “restaurant K”.

### <Flow of Processes by Management Server>

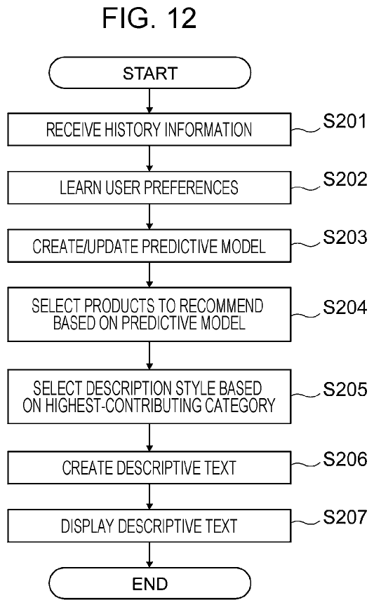

Next, the flow of processes by the management server 10 will be described. FIG. 12 is a flowchart illustrating a flow of processes by the management server 10.

First, the transmitting-receiving unit 12 of the management server 10 receives history information transmitted from the user terminal 20 (S201).

On the basis of the history information, the learning unit 13 learns user preferences regarding products from multiple categories (S202). Subsequently, on the basis of the learning results, predictive models are created and created predictive models are updated (S203).

The selection unit 14 selects a product to recommend to a user on the basis of the predictive models created by the learning unit 13 (S204). Also, a description style of the descriptive text of the product is selected on the basis of the category that contributed the most to the selection of the product from among the multiple categories to which the user preferences belong (S205).

The descriptive text creation unit 15 creates a descriptive text of the product selected by the selection unit 14 on the basis of the description style selected by the selection unit 14 (S206). Additionally, the created descriptive text is transmitted to the user terminal 20 via the transmitting-receiving unit 12 and displayed on the user terminal 20 (S207).

In this way, in the present exemplary embodiment, a product to recommend to the user is decided on the basis of history information related to a selection history of products that the user has selected and a search history of products that the user has searched for. Additionally, a description style of the descriptive text describing the product is specified on the basis of the category that contributed the most to the decision of the product from among the multiple categories to which the user preferences belong. In other words, the description style is specified on the basis of the decision basis when deciding the product.

Also, in the present exemplary embodiment, indicators that relate to user preferences regarding products are computed on the basis of history information, and the product to treat as the recommendation target is decided on the basis of the computed indicators. In this case, the decision basis when deciding the product to treat as the recommendation target is the category to which belong the user preferences that relate to an indicator that acts as the motive for deciding the product to treat as the recommendation target.

More specifically, in the present exemplary embodiment, indicators that relate to user preferences regarding products in multiple categories to which the user preferences belong are computed, and the product to treat as the recommendation target is decided on the basis of the computed indicators in the multiple categories. In this case, the decision basis when deciding the product to treat as the recommendation target is the category of the indicator that contributed the most to the decision of the product to treat as the recommendation target from among the indicators in multiple categories.

Note that after recommending a product to a user using a descriptive text in the description style selected according to the technique of the second exemplary embodiment, history information related to a user selection with respect to the recommended product may also be acquired. In this case, machine learning is performed on the basis of the acquired history information to learn user preferences regarding products, user preferences regarding the description styles of descriptive text, and the compatibility between products and the description styles of descriptive text, and a predictive model is created on the basis of the learning results. Subsequently, the created predictive model may be used to decide a product to recommend to the user and a description style of the descriptive text describing the product to recommend. In other words, after recommending products to a user using descriptive text in the description styles selected according to the technique of the second exemplary embodiment, when history information related to the recommended products is accumulated, the flow may be switched to use the history information to set a description style according to the technique of the first exemplary embodiment. The condition for switching may be that at least a predetermined amount of history information has been accumulated, or that the accumulation of history information has been performed for at least a predetermined period.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a display that displays a descriptive text describing an object;
an acquirer that, in a case in which multiple objects described by the descriptive text exist, acquires information about a description format of the descriptive text describing a first object selected by a user;
a specifier that specifies the description format that the user prefers based on the information about the description format acquired by the acquirer;
a recommendation target decider that decides a recommendation target to recommend to the user from among the multiple objects; and
a descriptive text display that displays a descriptive text describing the decided recommendation target based on the description format specified by the specifier.

2. The information processing system according to claim 1, wherein
the acquirer acquires information about a description format of a descriptive text describing a second object not selected by the user, and
the specifier specifies the description format based on the information about the description format of the descriptive text associated with the first object selected by the user and the information about the description format of the descriptive text associated with the second object not selected by the user.

3. The information processing system according to claim 2, further comprising:
a calculator that calculates an indicator related to a user preference regarding the description format, based on the information about the description format of the descriptive text associated with the first object selected by the user and the information about the description format of the descriptive text associated with the second object not selected by the user, wherein
the specifier specifies the description format based on the indicator calculated by the calculator.

4. The information processing system according to claim 1, wherein
the description format of the descriptive text displayed by the descriptive text display is a format of a description related to a basis for recommending the recommendation target to the user.

5. The information processing system according to claim 4, wherein
the format of the description related to the basis is a format of a description of a feature of the recommendation target in a category to which the user preference belongs.

6. The information processing system according to claim 1, further comprising:
a storage unit that stores the information about the description format acquired by the acquirer; and
a calculator that calculates a compatibility indicator related to a compatibility between the object and the description format, based on the information stored in the storage unit, wherein
the specifier specifies the description format on a basis of the compatibility indicator.

7. The information processing system according to claim 6, wherein
the calculator calculates the compatibility indicator related to the compatibility between the recommendation target decided by the recommendation target decider and the description format, and
the specifier specifies the description format based on the compatibility indicator associated with the recommendation target decided by the recommendation target decider.

8. The information processing system according to claim 6, wherein
the calculator calculates the compatibility indicator related to the compatibility between the description format specified by the specifier and the object, and
the recommendation target decider decides the recommendation target based on the compatibility indicator associated with the description format specified by the specifier.

9. The information processing system according to claim 6, wherein
the specifier specifies the description format and the recommendation target decider also decides the recommendation target based on the compatibility indicator.

10. The information processing system according to claim 1, wherein
the information about the description format acquired by the acquirer includes information related to a number of description formats used in the descriptive text describing the first object selected by the user, and
the specifier specifiers a number of description formats that the user prefers.

11. An information processing system comprising:
a display that displays a descriptive text describing an object;
an acquirer that, in a case in which multiple objects described by the descriptive text exist, acquires information about a description format of the descriptive text describing a first object selected by a user;
a specifier that specifies a combination of the first object and the description format that the user prefers, based on the information about the description format acquired by the acquirer; and
a descriptive text display that displays a descriptive text describing the first object based on the description format specified by the specifier.

12. An information processing system comprising:
a display that displays a descriptive text describing an object;
an acquirer that, in a case in which multiple objects described by the descriptive text exist, acquires history information related to a selection history of first objects selected by the user and/or a search history of first objects searched for by the user;
a recommendation target decider that decides a recommendation target to recommend to the user from among the multiple objects based on the history information;
a specifier that specifies the description format of the descriptive text describing the recommendation target based on a decision basis when the recommendation target decider decides the recommendation target; and
a descriptive text display that displays the descriptive text describing the recommendation target decided by the recommendation target decider based on the description format specified by the specifier.

13. The information processing system according to claim 12, further comprising:
a calculator that calculates an indicator related to a user preference regarding the object based on the history information, wherein
the recommendation target decider decides the recommendation target based on the indicator, and
the decision basis is a category to which belongs the user preference related to the indicator that acts as a motive by which the recommendation target decider decides the recommendation target.

14. The information processing system according to claim 13, further comprising:
a storage unit that stores the history information acquired by the acquirer, wherein
the calculator calculates indicators in multiple categories to which preferences of the user belong, based on information stored in the storage unit,
the recommendation target decider decides the recommendation target based on the indicators in the multiple categories, and
the decision basis is the category of the indicator that contributes most to the decision of the recommendation target from among the indicators in the multiple categories.
